(19) United States
(12) Patent Application Publication
(10) Pub. No.: US 2021/0067265 A1
(43) Pub. Date: Mar. 4, 2021

(54) Jammer Detection and Mitigation

(71) Applicant: QUALCOMM Incorporated, San Diego, CA (US)

(72) Inventors: Ravi AGARWAL, San Diego, CA (US); Gavin Bernard Horn, La Jolla, CA (US); Soo Bum Lee, San Diego, PA (US); Naga Bhushan, San Diego, CA (US); Ozcan Ozturk, San Diego, CA (US)

(21) Appl. No.: 17/005,931

(22) Filed: Aug. 28, 2020

Related U.S. Application Data
(60) Provisional application No. 62/895,118, filed on Sep. 3, 2019.

(51) Int. Cl. H04K 3/00; H04B 17/309

(52) U.S. Cl. CPC H04K 3/224; H04B 17/309

(57) ABSTRACT

Methods for detecting and responding to detecting a non-benign network entity (e.g., jammer, etc.) that targets physical layer channels in a communication network. A wireless device may receive a physical downlink control channel (PDCCH) and a demodulation reference signal (DMRS) from a network entity, determine radio signal strength indicator (RSSI) for the received PDCCH, determine a signal to noise ratio (SNR) for the DMRS, determine whether the RSSI satisfies a first threshold, and determine whether the DMRS SNR satisfies a second threshold.

### RELATED APPLICATIONS

This application claims the benefit of priority to U.S. Provisional Application No. 62/895,118, entitled “Jammer Detection and Mitigation” filed Sep. 3, 2019, the entire contents of which are hereby incorporated by reference for all purposes.

### BACKGROUND

Long Term Evolution (LTE), 5G new radio (NR), and other recently developed communication technologies allow wireless devices to communicate information at data rates (e.g., in terms of Gigabits per second, etc.) that are orders of magnitude greater than what was available just a few years ago. Today's communication networks are also more secure, resilient to multipath fading, allow for lower network traffic latencies, and provide better communication efficiencies (e.g., in terms of bits per second per unit of bandwidth used, etc.). These and other recent improvements in communication technologies have facilitated the emergence of the Internet of Things (IOT), large scale Machine to Machine (M2M) communication systems, autonomous vehicles, and other technologies that rely on consistent and secure wireless communications. As a result, billions of small, mobile, or resource constrained computing devices (e.g., smartphones, watches, smart appliances, autonomous vehicles, etc.) now use Internet protocol (IP) and cellular communication networks to communicate critical and mundane information.

Concurrent with the above trends, software defined radio (SDR) chips and universal software radio peripheral (USRP) boards have become less expensive and are now widely available. Open source LTE/3G stacks (srsLTE, openLTE, OpenBTS-UMTS, etc.) allow programmers to quickly install and operate a base station via a laptop computer. These technologies have dramatically reduced the costs associated with setting up and operating a base station in a shell telecommunication network.

Due to these trends, wireless devices and cellular communication networks are increasingly vulnerable to fake base stations and jammers that deliberately transmit communication signals to jam or overwhelm the base stations of network service providers, launch denial of service attacks, drain the battery and processing resources of resource constrained computing devices (e.g., IOT devices, smartphones, etc.), or otherwise disrupt or hinder the services provided by communication networks and service providers.

### SUMMARY

Various aspects include methods performed by a processor of wireless device for detecting a jammer that targets physical layer channels in a communication network. Various aspects may include receiving a physical downlink control channel (PDCCH) and a demodulation reference signal (DMRS) from a network entity, determining a signal to noise ratio (SNR) for the DMRS, determining whether the DMRS SNR satisfies a threshold, decoding at least a portion of the cyclic redundancy check (CRC) bits associated with the PDCCH, determining whether the decoded CRC bits match expected CRC bits, determining whether the network entity is non-benign based on a result of the determination of whether the decoded CRC bits match the expected CRC bits and a result of the determination of whether the DMRS SNR satisfies the threshold, and performing a mitigation operation in response to determining that the network entity is a non-benign network entity. In some aspects, determining whether the network entity is non-benign may include determining that the network entity is non-benign in response to determining that the decoded CRC bits do not match expected CRC bits and the DMRS SNR satisfies the threshold. In some aspects, decoding at least a portion of the CRC bits associated with the PDCCH may include decoding at least a portion of the CRC bits associated with the PDCCH in response to determining that the DMRS SNR satisfies the threshold.

Some aspects may include incrementing a jamming event counter in response to determining that the decoded CRC bits do not match expected CRC bits and the DMRS SNR satisfies the threshold, determining whether the jamming event counter satisfies a jamming event threshold in response to incrementing the jamming event counter, and determining that the network entity is a non-benign network entity in response to determining that the jamming event counter satisfies a jamming event threshold.

In some aspects, performing a mitigation operation in response to determining that the network entity is a non-benign network entity may include updating, by the processor in the wireless device, one or more communication parameters to access the communication network using a different frequency, a different band or a different system. In some aspects, performing a mitigation operation in response to determining that the network entity is a non-benign network entity may include monitoring, by the processor in the wireless device, activities of the network entity. In some aspects, performing a mitigation operation in response to determining that the network entity is a non-benign network entity may include reporting the activities of the network entity to a security server of the communication network.

Further aspects include a wireless device having a wireless transceiver and a processor coupled to the wireless transceiver and configured with processor-executable instructions to perform operations corresponding to any of the methods summarized above. Further aspects include a wireless device having means for performing functions corresponding to any of the methods summarized above. Further aspects include a non-transitory processor-readable storage medium having stored thereon processor-executable instructions configured to cause a processor of a wireless device to perform operations corresponding to any of the methods summarized above.

Further aspects include methods performed by a processor of a server computing device, which may include detecting a jammer that targets physical layer channels in a communication network by setting non-device specific cyclic redundancy check (CRC) bits associated with a physical downlink control channel (PDCCH) so that the CRC bits are agnostic to (or so the CRC bits are not dependent on) an identity of a target of the PDCCH. In some aspects, setting non-device specific CRC bits associated with the PDCCH so that the CRC bits are agnostic to the identity of the target of the PDCCH may include setting a network parameter N_RNTI=0 for devices in a cell (e.g., all the wireless devices in the cell). In some aspects, setting non-device specific CRC bits associated with the PDCCH so that the CRC bits are agnostic to the identity of the target of the PDCCH may further include setting a network parameter N_ID to be the same for the devices in the cell.

Further aspects include a server computing device having a processor configured with processor-executable instructions to perform operations corresponding to any of the methods summarized above. Further aspects include a server computing device having means for performing functions corresponding to any of the methods summarized above. Further aspects include a non-transitory processor-readable storage medium having stored thereon processor-executable instructions configured to cause a processor of a server computing device to perform operations corresponding to any of the methods summarized above.

### BRIEF DESCRIPTION OF THE DRAWINGS

The accompanying drawings, which are incorporated herein and constitute part of this specification, illustrate example embodiments of the invention, and, together with the general description given above and the detailed description given below, serve to explain features of the invention.

FIG. 1 is a communication system block diagram illustrating network components of example telecommunication systems suitable for use with various embodiments.

FIG. 2 is a component block diagram of an example computing system that could be configured to detect and respond to fake emergency messages and fake presidential alerts in accordance with various embodiments.

FIG. 3 is a component block diagram of an example software architecture of a wireless device including a radio protocol stack for the user and control planes in wireless communications.

FIGS. 4-8 are processor flow diagrams that illustrate methods that may performed by a processor of wireless device for detecting a jammer that targets physical layer channels in a communication network in accordance with various embodiments.

FIG. 9 is a processor flow diagram that illustrates a method that may performed by a processor of server computing device or network component for detecting a jammer that targets physical layer channels in a communication network in accordance with an embodiment.

FIG. 10 is a processor flow diagram illustrating a method that may performed by a processor of wireless device for detecting a jammer that targets physical layer channels in a communication network in accordance with an embodiment.

FIG. 11 is a component block diagram of an example server computing device suitable for implementing various embodiments.

FIG. 12 is a component block diagram illustrating a wireless device suitable for implementing various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments include methods, and components (e.g., base stations, wireless devices, server computing devices, etc.) configured to implement the methods, for detecting and responding to non-benign network entities, such as rouge base stations or jamming devices that target physical layer channels.

Some embodiments may include a network component (e.g., a base station, server computing device, etc.) that is configured to set the network parameter N_RNTI=0 and the network parameter N_ID to be the same for all the wireless devices in a cell. This may allow any wireless device in the cell that receives a signal that includes the physical downlink control channel (PDCCH) from the network component to be able to decode at least a portion of the cyclic redundancy check (CRC) bits/values associated with the PDCCH.

Generally, a network component (e.g., base station, server computing device, etc.) may transmit a physical downlink control channel (PDCCH) on an aggregation of one or more consecutive control channel elements (CCEs) in a control resource set (CORESET). The PDCCH may be associated with a demodulation reference signal (DMRS), which may be transmitted using the same precoding matrix as the PDCCH. In some embodiments, the network component may be configured to avoid transmitting PDCCH DMRS outside of the CCE's allocated for PDCCH transmission.

Various embodiments include a wireless device that is configured to determine whether a base station is a non-benign network entity based on a signal strength, a signal quality, and one or more CRC bits/values associated with the PDCCH. The wireless device may be configured to receive the PDCCH and DMRS, determine a radio signal strength indicator (RSSI) for the received PDCCH, determine a signal to noise ratio (SNR) for the DMRS, determine whether the RSSI satisfies (e.g., meets or exceeds) a high threshold (i.e., whether the signal strength is high), and determine whether the DMRS SNR satisfies (e.g., meets or exceeds) a low threshold (i.e., whether the signal quality is low).

In response to determining that the PDCCH RSSI satisfies the high threshold and the DMRS SNR is less than the low threshold, the wireless device may determine that the base station is a suspicious or non-benign network entity. In some embodiments, the wireless device may determine that a “jamming event” occurred and increment a jamming event counter in response to determining that the PDCCH RSSI satisfies the high threshold and the DMRS SNR is less than the low threshold.

In response to determining that the DMRS SNR is not less than the low threshold (i.e., the signal quality is higher than the low threshold), the wireless device may decode all or a portion of the CRC bits/values associated with the PDCCH, and determine whether the decoded CRC bits/values match expected CRC bits/values. The wireless device may determine that a “jamming event” occurred in response to determining that the decoded CRC bits/values do not match the expected CRC bits/values. The wireless device may increment a jamming event counter, determine whether the jamming event counter satisfies a jamming event threshold, and determine that the base station is a suspicious or non-benign network entity in response to determining that the jamming event counter satisfies the threshold value.

In response to determining that the base station is a suspicious or non-benign network entity, the wireless device may take an action to mitigate or otherwise respond to an attack, such as by using a different frequency, band or system to access the communication network. The wireless device may also report the activities of the network entity to a security server deployed in the cellular or telecommunication network, and/or perform other similar responsive or mitigating operations.

In some embodiments, the jamming event threshold may be value representing a moving window of t PDCCH decoding attempts.

In some embodiments, the jamming event counter may identify the number of jamming events n in a moving window of t PDCCH decoding attempts. In some embodiments, the jamming event counter may identify the number of jamming events n in a moving window of t PDCCH decoding attempts with high DMRS SNR.

A number of different cellular and mobile communication services and standards are available or contemplated in the future, all of which may implement and benefit from the various embodiments. Such services and standards include, e.g., third generation partnership project (3GPP), long term evolution (LTE) systems, third generation wireless mobile communication technology (3G), fourth generation wireless mobile communication technology (4G), fifth generation wireless mobile communication technology (5G), global system for mobile communications (GSM), universal mobile telecommunications system (UMTS), 3GSM, general packet radio service (GPRS), code division multiple access (CDMA) systems (e.g., cdmaOne, CDMA2000™), enhanced data rates for GSM evolution (EDGE), advanced mobile phone system (AMPS), digital AMPS (IS-136/TDMA), evolution-data optimized (EV-DO), and digital enhanced cordless telecommunications (DECT). Each of these technologies involves, for example, the transmission and reception of voice, data, signaling, and/or content messages. It should be understood that any references to terminology and/or technical details related to an individual telecommunication standard or technology are for illustrative purposes only, and are not intended to limit the scope of the claims to a particular communication system or technology unless specifically recited in the claim language.

The terms “wireless device” and “wireless device” may be used interchangeably herein to refer to any one or all of internet-of-things (IOT) devices, cellular telephones, smartphones, personal or mobile multi-media players, personal data assistants (PDA's), laptop computers, tablet computers, ultrabooks, palm-top computers, wireless electronic mail receivers, multimedia Internet enabled cellular telephones, wireless gaming controllers, smart cars, autonomous vehicles, and similar electronic devices which include a programmable processor, a memory and circuitry for sending and/or receiving wireless communication signals. While various embodiments are particularly useful in wireless devices, such as smartphones and tablets, the embodiments are generally useful in any electronic device that includes communication circuitry for accessing wireless Internet Protocol (IP) and data services through cellular and wireless communication networks.

The term “system on chip (SOC)” is used herein to refer to a single integrated circuit (IC) chip that contains multiple resources and/or processors integrated on a single substrate. A single SOC may contain circuitry for digital, analog, mixed-signal, and radio-frequency functions. A single SOC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.). SOCs may also include software for controlling the integrated resources and processors, as well as for controlling peripheral devices.

The term “system in a package (SIP)” may be used herein to refer to a single module or package that contains multiple resources, computational units, cores and/or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP may also include multiple independent SOCs coupled together via high speed communication circuitry and packaged in close proximity, such as on a single motherboard or in a single wireless device. The proximity of the SOCs facilitates high speed communications and the sharing of memory and resources.

The term “multicore processor” may be used herein to refer to a single integrated circuit (IC) chip or chip package that contains two or more independent processing cores (e.g., CPU core, Internet protocol (IP) core, graphics processor unit (GPU) core, etc.) configured to read and execute program instructions. A SOC may include multiple multicore processors, and each processor in an SOC may be referred to as a core. The term “multiprocessor” may be used herein to refer to a system or device that includes two or more processing units configured to read and execute program instructions.

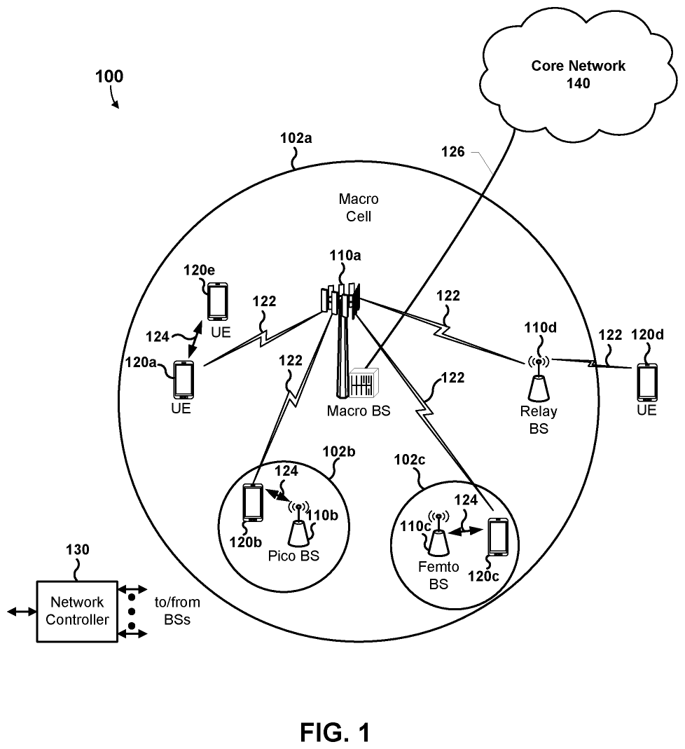

Generally, numerology refers to a group of telecommunication parameters called bandwidth parts (BWP), which in orthogonal frequency division multiplexing (OFDM) include subcarrier spacing (SCS or Δf), slot duration, symbol length, cyclic prefix (CP), cyclic prefix duration, and other parameters that define the frame and lattice structure of the waveform. In 5G NR, the numerology may be based on exponentially scalable sub-carrier spacing (e.g., Δf=2μ×15 kHz) with μ={0, 1, 3, 4} for the primary synchronization signal (PSS), secondary synchronization signal (SSS) and physical broadcast channel (PBCH), and μ={0, 1, 2, 3} for other channels. A 5G NR capable wireless device (e.g., wireless device 120a-120e discussed below with reference to FIG. 1) may be configured with multiple BWPs on a given component carrier, but only one BWP may be active at a time. The active BWP defines the wireless device's operating bandwidth within the cell's operating bandwidth.

5G NR downlink (DL) and uplink (UL) transmissions may be organized into frames of 10 ms duration. Each frame may include ten 1 ms subframes. Each subframe may include one or more slots. A slot may include 12 or 14 symbols (time domain resources) across a number of subcarriers. The slots may scale in time as a function of the sub-carrier spacing so that there is always an integer number of slots in a subframe. As an example, for numerology μ=0, each subframe includes one slot of 14 symbols, and thus the slot duration is 1 ms. For numerology μ=1, each subframe includes 2 slots, and thus the slot duration is 0.5 ms.

As mention above, a symbol is a time domain resource that carries information. A resource block (RB) is a frequency domain resource that carries information. A resource block may include 12 consecutive resource elements (subcarriers) in the frequency domain and may be 1 slot long in time.

The physical downlink control channel (PDCCH) may be used to send physical layer information to the wireless device on a per-slot basis. The PDCCH may be included in any subcarrier of the slot, may start in the first symbol of each slot, may be Quadrature Phase Shift Keying (QPSK) modulated, and may use polar coding.

The PDCCH typically occupies one symbol of a slot. Within that slot, some of the tones/frequencies (or resource elements, RBs, etc.) are allocated for demodulation reference signals (DMRS). The other tone/frequencies in the slot are allocated for non-DMRS, and correspond to the information carried by the PDCCH. For example, the non-DMRS tone/frequencies may identify the time and frequency resources being allocated for the data channel corresponding to the PDCCH.

Not all wireless devices that receive the PDCCH are the target of the PDCCH. Yet, many or all of the wireless devices that receive the PDCCH may be able to decode at least a portion of the PDCCH.

Generally, PDCCH DMRS uses a Gold sequence initialized by N_{ID}, with PDCCH non-DMRS symbols (including CRC) scrambled using N_{ID}, N_{RNTI}, where:
N_{ID}ε{0, 1, . . . , 2¹⁶−1} for user equipment (LTE) specific search space (USS) if provided by RRC,
N_{ID}=N_{ID}^{cell} otherwise
N_{RNTI}=Cell Radio Network Temporary Identifier ε{0, 1, . . . , 2¹⁶1} for USS if N_{ID} provided by RRC,
N_{RNTI}=0 otherwise.

The CRC of the PDCCH may be 24 bits long, and 16 of those bits may be specific to the wireless device that is the target of the PDCCH. In various embodiments, the remaining 8 non-device specific bits may be agnostic to (or so the CRC bits are not dependent on) the identity of the target of the PDCCH. In some embodiments, this may be accomplished by the network component (e.g., base station, etc.) setting the network parameter N_RNTI=0 for all wireless devices in the cell and the network parameter N_ID to be the same for all the wireless devices in the cell. This will allow any wireless device in cell that receives the PDCCH to decode at least the 8 agnostic CRC bits. In some embodiments, the network component (e.g., base station, etc.) may be configured to set the 8 non-device specific bits of the 24 CRC bits associated with the PDCCH to be agnostic so that any wireless device in the cell that receives the PDCCH can decode and evaluate/check at least those 8 bits.

Generally, wireless devices monitor for a physical downlink control channel (PDCCH), which may be transmitted on an aggregation of one or more consecutive control channel elements (CCEs) in a control resource set (CORESET). The PDCCH carries or communicates physical layer specific information, such as the resources that are identified for the data channel, transmit power control information for determining whether to increase or decrease the transmit power, scheduling assignments and other control information used by the wireless device uses to receive and decode a data channel and its corresponding data.

A jammer or blocker is a device that deliberately transmits wireless communication signals (or jamming signals) to disrupt wireless communications between the wireless device and the base station. A PDCCH jammer transmits high noise jamming signals that prevent the wireless device from being able to decode the PDCCH. A wireless device that is unable to decode the PDCCH may not be able to receive and decode a data channel, or use the communication network to send or receive data messages. For example, on the downlink, a PDCCH jammer may prevent the wireless device from receiving or decoding the RMSI (SIB1), the Other SI, Msg2 of the attach procedure, downlink grants or the associated radio resource control (RRC) signaling/data (for decoding signaling messages), or aperiodic channel status information (A-CSI) report triggers. On the uplink, the PDCCH jammer may prevent the wireless device from receiving or decoding uplink grants or the associated signaling/traffic, aperiodic sounding reference signal (SRS) triggers, or the power control commands for the physical uplink control channel (PUCCH) or physical uplink shared channel (PUSCH). For all these reasons, a PDCCH jammer may prevent a wireless device from decoding the PDCCH or using the communication network.

A transmission with a high PDCCH RSSI and low DMRS SNR (e.g., a high signal strength and a low signal quality) may indicate that an assumed base station is PDCCH jammer. However, a smart PDCCH jammer may attempt to avoid detection by wireless devices that test for high signal strength and low signal quality by selectively excluding the PDCCH DMRS from the precoding matrix or PDCCH transmission. This may cause the wireless device to determine that the level of noise is low, that the quality of the signal is high, or that the received signals exhibit a high signal-to-noise ratio. Further, a wireless device may not be able to readily detect that the precoding matrix or PDCCH transmission that does not include PDCCH DMRS, and the exclusion PDCCH DMRS may not necessarily indicate the presence of a PDCCH jammer. For all these reasons, a smart PDCCH jammer that selectively excludes the PDCCH DMRS may avoid detection by a wireless device that only monitors for a high PDCCH RSSI and low DMRS SNR.

A high signal quality (e.g., a high DMRS SNR) should allow all of the wireless devices in a cell that receive the PDCCH to decode all or a subset of the CRC bits/values in the PDCCH. Further, setting the network parameter N_RNTI=0 and the network parameter N_ID to be the same for all of the wireless devices in the cell may allow any wireless device in that cell that receives the PDCCH to determine the correct expected CRC bits/values. As such, in some embodiments, the wireless device may be configured to receive a PDCCH signal from a base station, determine its signal quality (e.g., DMRS SNR), determine whether the signal quality satisfies a high threshold. In response to determining that the signal quality satisfies the high threshold, the wireless device may determine the expected CRC bits/values for the PDCCH signal, decode all or a portion of the CRC bits/values associated with the PDCCH, and determine whether the decoded CRC bits/values match the expected CRC bits/values. The wireless device may determine that the base station is a suspicious or non-benign network entity in response to determining that the signal quality is high but the decoded CRC bits/values do not match the expected check bits/values. By checking the CRC bits/values associated with the PDCCH when the DMRS SNR is high, the various embodiments may allow the wireless device to detect smart PDCCH jammers that selectively exclude the PDCCH DMRS.

In some embodiments, the wireless device may be configured to not increment the jamming event counter in response to determining that the DMRS SNR is not less than the low threshold (i.e., that the signal quality is high) and the decoded CRC bits/values do not match the expected CRC bits/values.

If the wireless device a first control channel element (CCE) aggregation level (agg level L) and second wireless device monitors another CCE aggregation (agg level M), and the network component schedules the second wireless device on agg level M, there is a high probability that the wireless device will not be able to successfully decode and evaluate/check the first 8 bits of the 24 CRC bits associated with the PDCCH. As such, in some embodiments, the network component may be configured to ensure that all devices in the cell are configured with the same set of control channel element (CCE) aggregation levels to monitor within a control resource set (CORESET). This may allow every wireless device to correctly decode and check the first 8 CRC bits when the DMRS SNR is not less than the low threshold (i.e., in high SNR), regardless of the aggregation level (agg level L, agg level M) scheduled by network.

If the wireless device is configured with non-interleaved CORESET and a second wireless device is configured with interleaved CORESET, there is a high probability that the wireless device will not be able to successfully decode and evaluate/check the first 8 bits of the 24 CRC bits associated with the PDCCH. In some embodiments, the network component may be configured to ensure that all devices in the cell are configured with interleaved or non-interleaved for a particular CORESET. This may allow every wireless device to correctly decode and check the first 8 CRC bits when the DMRS SNR is not less than the low threshold (i.e., in high SNR).

FIG. 1 illustrates an example of a communications system 100 that is suitable for implementing various embodiments. The communications system 100 may be an 5G NR network, or any other suitable network such as an LTE network.

The communications system 100 may include a heterogeneous network architecture that includes a core network 140 and a variety of mobile devices (illustrated as wireless device 120a-120e in FIG. 1). The communications system 100 may also include a number of base stations (illustrated as the BS 110a, the BS 110b, the BS 110c, and the BS 110d) and other network entities. A base station is an entity that communicates with wireless devices (mobile devices), and also may be referred to as an NodeB, a Node B, an LTE evolved nodeB (eNB), an access point (AP), a radio head, a transmit receive point (TRP), a New Radio base station (NR BS), a 5G NodeB (NB), a Next Generation NodeB (gNB), or the like. Each base station may provide communication coverage for a particular geographic area. In 3GPP, the term “cell” can refer to a coverage area of a base station, a base station subsystem serving this coverage area, or a combination thereof, depending on the context in which the term is used.

A base station 110a-110d may provide communication coverage for a macro cell, a pico cell, a femto cell, another type of cell, or a combination thereof. A macro cell may cover a relatively large geographic area (for example, several kilometers in radius) and may allow unrestricted access by mobile devices with service subscription. A pico cell may cover a relatively small geographic area and may allow unrestricted access by mobile devices with service subscription. A femto cell may cover a relatively small geographic area (for example, a home) and may allow restricted access by mobile devices having association with the femto cell (for example, mobile devices in a closed subscriber group (CSG)). A base station for a macro cell may be referred to as a macro BS. A base station for a pico cell may be referred to as a pico BS. A base station for a femto cell may be referred to as a femto BS or a home BS. In the example illustrated in FIG. 1, a base station 110a may be a macro BS for a macro cell 102a, a base station 110b may be a pico BS for a pico cell 102b, and a base station 110c may be a femto BS for a femto cell 102c. A base station 110a-110d may support one or multiple (for example, three) cells. The terms “eNB”, “base station”, “NR BS”, “gNB”, “TRP”, “AP”, “node B”, “5G NB”, and “cell” may be used interchangeably herein.

In some examples, a cell may not be stationary, and the geographic area of the cell may move according to the location of a mobile base station. In some examples, the base stations 110a-110d may be interconnected to one another as well as to one or more other base stations or network nodes (not illustrated) in the communications system 100 through various types of backhaul interfaces, such as a direct physical connection, a virtual network, or a combination thereof using any suitable transport network.

The base station 110a-110d may communicate with the core network 140 over a wired or wireless communication link 126. The wireless device 120a-120e may communicate with the base station 110a-110d over a wireless communication link 122.

The wired communication link 126 may use a variety of wired networks (e.g., Ethernet, TV cable, telephony, fiber optic and other forms of physical network connections) that may use one or more wired communication protocols, such as Ethernet, Point-To-Point protocol, High-Level Data Link Control (HDLC), Advanced Data Communication Control Protocol (ADCCP), and Transmission Control Protocol/Internet Protocol (TCP/IP).

The communications system 100 also may include relay stations (e.g., relay BS 110d). A relay station is an entity that can receive a transmission of data from an upstream station (for example, a base station or a mobile device) and send a transmission of the data to a downstream station (for example, a wireless device or a base station). A relay station also may be a mobile device that can relay transmissions for other wireless devices. In the example illustrated in FIG. 1, a relay station 110d may communicate with macro the base station 110a and the wireless device 120d in order to facilitate communication between the base station 110a and the wireless device 120d. A relay station also may be referred to as a relay base station, a relay base station, a relay, etc.

The communications system 100 may be a heterogeneous network that includes base stations of different types, for example, macro base stations, pico base stations, femto base stations, relay base stations, etc. These different types of base stations may have different transmit power levels, different coverage areas, and different impacts on interference in communications system 100. For example, macro base stations may have a high transmit power level (for example, 5 to 40 Watts) whereas pico base stations, femto base stations, and relay base stations may have lower transmit power levels (for example, 0.1 to 2 Watts).

A network controller 130 may couple to a set of base stations and may provide coordination and control for these base stations. The network controller 130 may communicate with the base stations via a backhaul. The base stations also may communicate with one another, for example, directly or indirectly via a wireless or wireline backhaul.

The wireless devices 120a, 120b, 120c may be dispersed throughout communications system 100, and each wireless device may be stationary or mobile. A wireless device also may be referred to as an access terminal, a terminal, a mobile station, a subscriber unit, a station, etc. A wireless device 120a, 120b, 120c may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (for example, smart ring, smart bracelet)), an entertainment device (for example, a music or video device, or a satellite radio), a vehicular component or sensor, smart meters/sensors, industrial manufacturing equipment, a global positioning system device, or any other suitable device that is configured to communicate via a wireless or wired medium.

A macro base station 110a may communicate with the communication network 140 over a wired or wireless communication link 126. The wireless devices 120a, 120b, 120c may communicate with a base station 110a-110d over a wireless communication link 122.

The wireless communication links 122 and 124 may include a plurality of carrier signals, frequencies, or frequency bands, each of which may include a plurality of logical channels. The wireless communication links 122 and 124 may utilize one or more radio access technologies (RATs). Examples of RATs that may be used in a wireless communication link include 3GPP LTE, 3G, 4G, 5G (e.g., NR), GSM, Code Division Multiple Access (CDMA), Wideband Code Division Multiple Access (WCDMA), Worldwide Interoperability for Microwave Access (WiMAX), Time Division Multiple Access (TDMA), and other mobile telephony communication technologies cellular RATs. Further examples of RATs that may be used in one or more of the various wireless communication links within the communication system 100 include medium range protocols such as Wi-Fi, LTE-U, LTE-Direct, LAA, MuLTEfire, and relatively short range RATs such as ZigBee, Bluetooth, and Bluetooth Low Energy (LE).

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block”) may be 12 subcarriers (or 180 kHz). Consequently, the nominal Fast File Transfer (FFT) size may be equal to 128, 256, 512, 1024 or 2048 for system bandwidth of 1.25, 2.5, 5, 10 or 20 megahertz (MHz), respectively. The system bandwidth may also be partitioned into subbands. For example, a subband may cover 1.08 MHz (i.e., 6 resource blocks), and there may be 1, 2, 4, 8 or 16 subbands for system bandwidth of 1.25, 2.5, 5, 10 or 20 MHz, respectively.

While descriptions of some embodiments may use terminology and examples associated with LTE technologies, various embodiments may be applicable to other wireless communications systems, such as a new radio (NR) or 5G network. NR may utilize OFDM with a cyclic prefix (CP) on the uplink (UL) and downlink (DL) and include support for half-duplex operation using time division duplex (TDD). A single component carrier bandwidth of 100 MHz may be supported. NR resource blocks may span 12 sub-carriers with a sub-carrier bandwidth of 75 kHz over a 0.1 ms duration. Each radio frame may consist of 50 subframes with a length of 10 ms. Consequently, each subframe may have a length of 0.2 ms. Each subframe may indicate a link direction (i.e., DL or UL) for data transmission and the link direction for each subframe may be dynamically switched. Each subframe may include DL/UL data as well as DL/UL control data. Beamforming may be supported and beam direction may be dynamically configured. Multiple Input Multiple Output (MIMO) transmissions with precoding may also be supported. MIMO configurations in the DL may support up to eight transmit antennas with multi-layer DL transmissions up to eight streams and up to two streams per wireless device. Multi-layer transmissions with up to 2 streams per wireless device may be supported.

Aggregation of multiple cells may be supported with up to eight serving cells. Alternatively, NR may support a different air interface, other than an OFDM-based air interface.

Some mobile devices may be considered machine-type communication (MTC) or evolved or enhanced machine-type communication (eMTC) mobile devices. MTC and eMTC mobile devices include, for example, robots, drones, remote devices, sensors, meters, monitors, location tags, etc., that may communicate with a base station, another device (for example, remote device), or some other entity. A wireless node may provide, for example, connectivity for or to a network (for example, a wide area network such as Internet or a cellular network) via a wired or wireless communication link. Some mobile devices may be considered Internet-of-Things (IoT) devices or may be implemented as NB-IoT (narrowband Internet of things) devices. The wireless device 120a-e may be included inside a housing that houses components of the wireless device, such as processor components, memory components, similar components, or a combination thereof.

In general, any number of communications systems and any number of wireless networks may be deployed in a given geographic area. Each communications system and wireless network may support a particular radio access technology (RAT) and may operate on one or more frequencies. A RAT also may be referred to as a radio technology, an air interface, etc. A frequency also may be referred to as a carrier, a frequency channel, etc. Each frequency may support a single RAT in a given geographic area in order to avoid interference between communications systems of different RATs. In some cases, NR or 5G RAT networks may be deployed.

In some implementations, two or more mobile devices (for example, illustrated as the wireless device 120a and the wireless device 120e) may communicate directly using one or more sidelink channels (for example, without using a base station 110d as an intermediary to communicate with one another). For example, the wireless devices 120a-120e may communicate using peer-to-peer (P2P) communications, device-to-device (D2D) communications, a vehicle-to-everything (V2X) protocol (which may include a vehicle-to-vehicle (V2V) protocol, a vehicle-to-infrastructure (V2I) protocol, or similar protocol), a mesh network, or similar networks, or combinations thereof. In this case, the wireless device may perform scheduling operations, resource selection operations, as well as other operations described elsewhere herein as being performed by the base station 110a.

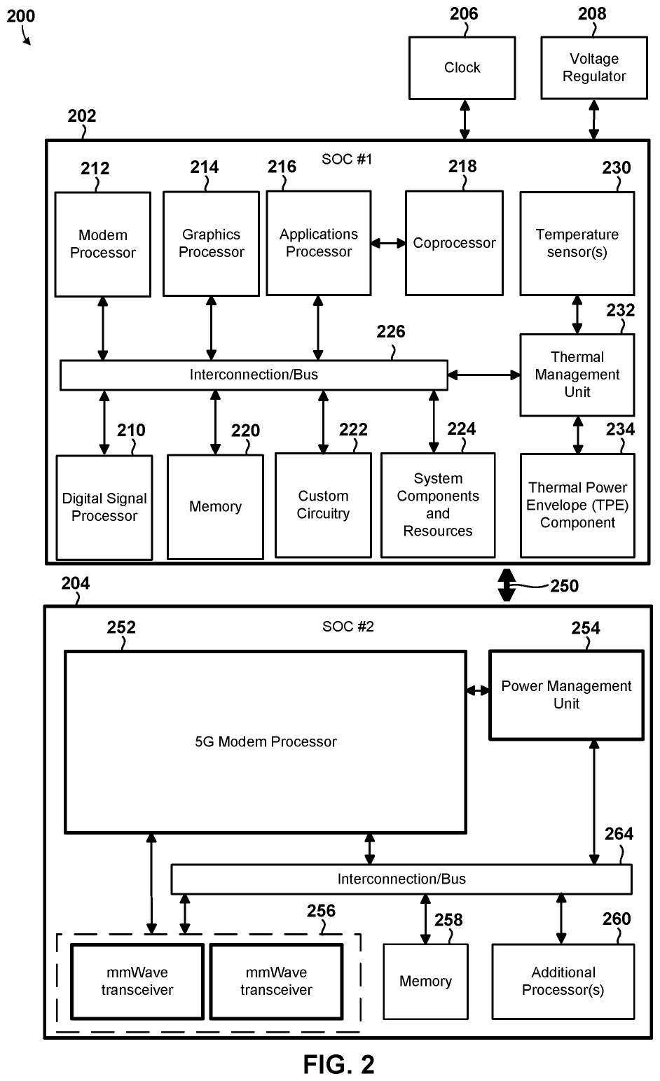

Various embodiments may be implemented on a number of single processor and multiprocessor computer systems, including a system-on-chip (SOC) or system in a package (SIP). FIG. 2 illustrates an example computing system or SIP 200 architecture that may be used in wireless devices implementing the various embodiments.

With reference to FIGS. 1 and 2, the illustrated example SIP 200 includes a two SOCs 202, 204, a clock 206, and a voltage regulator 208. In some embodiments, the first SOC 202 operate as central processing unit (CPU) of the wireless device that carries out the instructions of software application programs by performing the arithmetic, logical, control and input/output (I/O) operations specified by the instructions. In some embodiments, the second SOC 204 may operate as a specialized processing unit. For example, the second SOC 204 may operate as a specialized 5G processing unit responsible for managing high volume, high speed (e.g., 5 Gbps, etc.), and/or very high frequency short wave length (e.g., 28 GHz mmWave spectrum, etc.) communications.

The first SOC 202 may include a digital signal processor (DSP) 210, a modem processor 212, a graphics processor 214, an application processor 216, one or more coprocessors 218 (e.g., vector co-processor) connected to one or more of the processors, memory 220, custom circuity 222, system components and resources 224, an interconnection/bus module 226, one or more temperature sensors 230, a thermal management unit 232, and a thermal power envelope (TPE) component 234. The second SOC 204 may include a 5G modem processor 252, a power management unit 254, an interconnection/bus module 264, a plurality of mmWave transceivers 256, memory 258, and various additional processors 260, such as an applications processor, packet processor, etc.

Each processor 210, 212, 214, 216, 218, 252, 260 may include one or more cores, and each processor/core may perform operations independent of the other processors/cores. For example, the first SOC 202 may include a processor that executes a first type of operating system (e.g., FreeBSD, LINUX, OS X, etc.) and a processor that executes a second type of operating system (e.g., MICROSOFT WINDOWS 10). In addition, any or all of the processors 210, 212, 214, 216, 218, 252, 260 may be included as part of a processor cluster architecture (e.g., a synchronous processor cluster architecture, an asynchronous or heterogeneous processor cluster architecture, etc.).

The first and second SOC 202, 204 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 224 of the first SOC 202 may include power amplifiers, voltage regulators, oscillators, phase-locked loops, peripheral bridges, data controllers, memory controllers, system controllers, access ports, timers, and other similar components used to support the processors and software clients running on a wireless device. The system components and resources 224 and/or custom circuitry 222 may also include circuitry to interface with peripheral devices, such as cameras, electronic displays, wireless communication devices, external memory chips, etc.

The first and second SOC 202, 204 may communicate via interconnection/bus module 250. The various processors 210, 212, 214, 216, 218, may be interconnected to one or more memory elements 220, system components and resources 224, and custom circuitry 222, and a thermal management unit 232 via an interconnection/bus module 226. Similarly, the processor 252 may be interconnected to the power management unit 254, the mmWave transceivers 256, memory 258, and various additional processors 260 via the interconnection/bus module 264. The interconnection/bus module 226, 250, 264 may include an array of reconfigurable logic gates and/or implement a bus architecture (e.g., CoreConnect, AMBA, etc.). Communications may be provided by advanced interconnects, such as high-performance networks-on chip (NoCs).

The first and/or second SOCs 202, 204 may further include an input/output module (not illustrated) for communicating with resources external to the SOC, such as a clock 206 and a voltage regulator 208. Resources external to the SOC (e.g., clock 206, voltage regulator 208) may be shared by two or more of the internal SOC processors/cores.

In addition to the example SIP 200 discussed above, various embodiments may be implemented in a wide variety of computing systems, which may include a single processor, multiple processors, multicore processors, or any combination thereof.

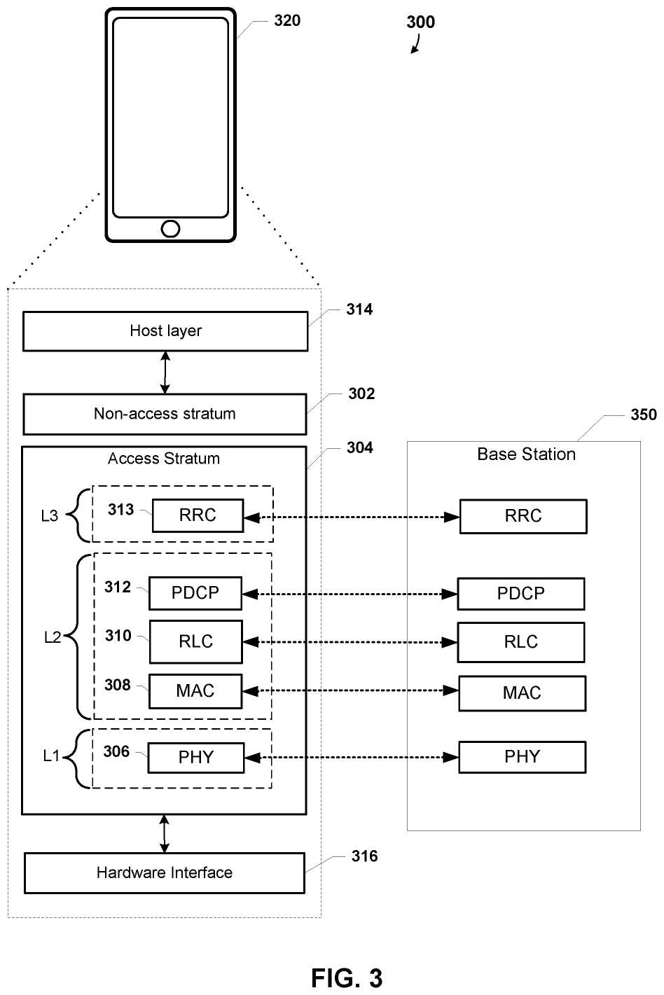

The 3rd Generation Partnership Project (3GPP) Radio Access Network (RAN) Telecommunication and Internet converged Services and Protocols for Advanced Networking (TISPAN) Working Group 4 (herein “3GPP RAN4”) is responsible for establishing standards and specification for the radio frequency (RF) aspects of modern cellular or telecommunication network. 3GPP RAN4 sets forth security and performance requirements at Layers 1 and 2 of the Open Systems Interconnection (OSI) model, which define the air interface of modern cellular or telecommunication networks. As is discussed below with reference to FIG. 3, Layer 1 is the physical layer (PHY) and includes various logical channels, including the Physical Downlink Control Channel (PDCCH) and the Physical Downlink Shared Channel (PDSCH). Layer 2 is the data link layer, and may be is divided into multiple protocol layers. In UMTS, LTE, and 5G NR, layer 2 protocol layers include the packet data convergence protocol (PDCP) layer, the radio link control (RLC) protocol layer, and the medium access control (MAC) protocol layer.

Many of the OSI layers and their respective protocols layers include or are associated with an end-to-end (E2E) or interface security solution. However, the PHY and the RLC/MAC layers/levels are not associated with an E2E or interface security solution, and conventional solutions do not provide adequately security for jamming resilience at the PHY or RLC/MAC layers/levels. As a result, modern networks remain vulnerable to jammers and fake base stations that jam or spoof the base stations of network service providers to launch denial of service attacks, drain the battery and processing resources of resource constrained computing devices, or otherwise disrupt or hinder the services provided by communication networks and service providers.

Wireless devices may address adjacent channel, in-band, out-of-band and narrow-band blocking via a combination of analog and digital filters in the wireless device. Because LTE systems do not actively detect or mitigate co-channel jamming in which the jammer frequency overlaps with the channel frequency, in some embodiments, the wireless device modem may be configured to collect and send a radio signal strength indicator (RSSI) and an acquisition result (e.g., success, fail, etc.) to the original equipment manufacturer (OEM). The OEM may implement a mitigating or responsive action if the acquisition results indicate that the acquisition failed and the RSSI satisfies a threshold value (e.g., RSSI is unusually high, etc.).

In some embodiments, the wireless device may be configured to perform baseband analysis of the received signals, and use the results of the baseband analysis to determine the probability that the received signals were generated by a wideband co-channel jammer. The wireless device may compare the determined probability to a threshold value, determine that there is a high probability that the received signals were generated by a wideband co-channel jammer in response to determining that the probability satisfies the threshold value, and perform a responsive or mitigating action in response to determining that there is a high probability that the received signals were generated by a wideband co-channel jammer. For example, the wireless device may use a different frequency, band or system to access the communication network or report potential jammer activities to the network (e.g., to a security server deployed in the cellular or telecommunication network).

In some embodiments, the wireless device may be configured to perform behavior based analysis operations to identify odd or non-benign behaviors, and use the results of the behavior based analysis operations to determine whether there is a high probability that the received signals were generated by a physical layer channel specific jammer (e.g., by comparing a determined probability value to a threshold value, etc.). The wireless device may perform a responsive or mitigating action in response to determining that there is a high probability the received signals were generated by a physical layer channel specific jammer. For example, the wireless device may use a different frequency, band or system to access the communication network or report potential jammer activities to the network (e.g., to a security server deployed in the cellular or telecommunication network). In addition, in some embodiments, mitigation may include building jammer resilient properties into L1 channels.

FIG. 3 illustrates an example of a software architecture 300 including a radio protocol stack for the user and control planes in wireless communications between a base station 350 (e.g., the base station 110a) and a wireless device 320 (e.g., the wireless device 120a-120e, 200). With reference to FIGS. 1-3, the wireless device 320 may implement the software architecture 300 to communicate with the base station 350 of a communication system (e.g., 100). In various embodiments, layers in software architecture 300 may form logical connections with corresponding layers in software of the base station 350. The software architecture 300 may be distributed among one or more processors (e.g., the processors 212, 214, 216, 218, 252, 260). While illustrated with respect to one radio protocol stack, in a multi-SIM (subscriber identity module) wireless device, the software architecture 300 may include multiple protocol stacks, each of which may be associated with a different SIM (e.g., two protocol stacks associated with two SIMs, respectively, in a dual-SIM wireless communication device). While described below with reference to LTE communication layers, the software architecture 300 may support any of variety of standards and protocols for wireless communications, and/or may include additional protocol stacks that support any of variety of standards and protocols wireless communications.

The software architecture 300 may include a Non-Access Stratum (NAS) 302 and an Access Stratum (AS) 304. The NAS 302 may include functions and protocols to support packet filtering, security management, mobility control, session management, and traffic and signaling between a SIM(s) of the wireless device (e.g., SIM(s) 204) and its core network 140. The AS 304 may include functions and protocols that support communication between a SIM(s) (e.g., SIM(s) 204) and entities of supported access networks (e.g., a base station). In particular, the AS 304 may include at least three layers (Layer 1, Layer 2, and Layer 3), each of which may contain various sub-layers.

In the user and control planes, Layer 1 (L1) of the AS 304 may be a physical layer (PHY) 306, which may oversee functions that enable transmission and/or reception over the air interface. Examples of such physical layer 306 functions may include cyclic redundancy check (CRC) attachment, coding blocks, scrambling and descrambling, modulation and demodulation, signal measurements, MIMO, etc. The physical layer may include various logical channels, including the Physical Downlink Control Channel (PDCCH) and the Physical Downlink Shared Channel (PDSCH).

In the user and control planes, Layer 2 (L2) of the AS 304 may be responsible for the link between the wireless device 320 and the base station 350 over the physical layer 306. In the various embodiments, Layer 2 may include a media access control (MAC) sublayer 308, a radio link control (RLC) sublayer 310, and a packet data convergence protocol (PDCP) 312 sublayer, each of which form logical connections terminating at the base station 350.

In the control plane, Layer 3 (L3) of the AS 304 may include a radio resource control (RRC) sublayer 3. While not shown, the software architecture 300 may include additional Layer 3 sublayers, as well as various upper layers above Layer 3. In various embodiments, the RRC sublayer 313 may provide functions INCLUDING broadcasting system information, paging, and establishing and releasing an RRC signaling connection between the wireless device 320 and the base station 350.

In various embodiments, the PDCP sublayer 312 may provide uplink functions including multiplexing between different radio bearers and logical channels, sequence number addition, handover data handling, integrity protection, ciphering, and header compression. In the downlink, the PDCP sublayer 312 may provide functions that include in-sequence delivery of data packets, duplicate data packet detection, integrity validation, deciphering, and header decompression.

In the uplink, the RLC sublayer 310 may provide segmentation and concatenation of upper layer data packets, retransmission of lost data packets, and Automatic Repeat Request (ARQ). In the downlink, while the RLC sublayer 310 functions may include reordering of data packets to compensate for out-of-order reception, reassembly of upper layer data packets, and ARQ.

In the uplink, MAC sublayer 308 may provide functions including multiplexing between logical and transport channels, random access procedure, logical channel priority, and hybrid-ARQ (HARQ) operations. In the downlink, the MAC layer functions may include channel mapping within a cell, de-multiplexing, discontinuous reception (DRX), and HARQ operations.

While the software architecture 300 may provide functions to transmit data through physical media, the software architecture 300 may further include at least one host layer 314 to provide data transfer services to various applications in the wireless device 320. In some embodiments, application-specific functions provided by the at least one host layer 314 may provide an interface between the software architecture and the general purpose processor 206.

In other embodiments, the software architecture 300 may include one or more higher logical layer (e.g., transport, session, presentation, application, etc.) that provide host layer functions. For example, in some embodiments, the software architecture 300 may include a network layer (e.g., IP layer) in which a logical connection terminates at a packet data network (PDN) gateway (PGW). In some embodiments, the software architecture 300 may include an application layer in which a logical connection terminates at another device (e.g., end user device, server, etc.). In some embodiments, the software architecture 300 may further include in the AS 304 a hardware interface 316 between the physical layer 306 and the communication hardware (e.g., one or more RF transceivers).

Generally, when a wireless device is powered on or is moved into a new geographical area, the wireless device performs cell search and selection operations, which may include detecting and decoding a primary synchronization signal (PSS) and a secondary synchronization signal (SSS) from a base station. The wireless device may receive and decode a physical broadcast channel (PBCH) to receive basic system configuration information in a master information block (MIB). The basic system configuration information may also include system bandwidth information, the number of transmit antennas used by the base station, physical hybrid automatic repeat request (hybrid-ARQ) indicator channel (PHICH) configuration information, a PHICH Ng value, a system frame number (SFN), and other similar information.

In addition, the wireless device may receive system information (SI) in system information messages or system information blocks (SIB). In LTE systems, SIB 1 may include scheduling information, cell access information and cell selection information, and SIBs 2-17 may include other well-defined types or categories of information (e.g., common channel configuration information, uplink frequency information, etc.). In 5G NR systems, the MIB and SIBs may be divided into “Minimum SI” and “Other SI.” The Minimum SI may include the MIB and SIB 1, and the Other SI may include all the SIBs not broadcast or sent as part of the Minimum SI. The MIB of the Minimum SI may include essential physical layer information for a cell, including configuration information for the control resource set (CORESET) for scheduling SIB1. The SIB 1 of the Minimum SI may include information for scheduling the other SIBs and information used as part of the initial access procedure. SIB1 is also sometimes referred to as Remaining Minimum SI (RMSI) in 5G NR systems.

A 5G NR capable wireless device may be configured to monitor for physical downlink control channel (PDCCH) candidates in monitoring occasions in one or more CORESETs. A CORESET may include physical resource blocks (PRBs) with a time duration of 1 to 3 symbols, resource element groups (REGs) and control channel elements (CCEs). Control channels may be formed by one or more of CCEs in a CORESET. That is, a PDCCH may be transmitted on an aggregation of one or more consecutive CCEs in a CORESET.

The physical downlink control channel (PDCCH) may be used to send physical layer information to the wireless device on a per-slot basis. The PDCCH may be included in any subcarrier of the slot, always starts in the first symbol of each slot, is Quadrature Phase Shift Keying (QPSK) modulated, and uses polar coding. The PDCCH may also be used to schedule downlink (DL) transmissions, uplink (UL) transmissions, modulation and coding format of those transmissions, and hybrid-ARQ information.

5G NR may implement a downlink transmission scheme in which a closed loop Demodulation Reference Signal (DMRS) based spatial multiplexing is supported for the Physical Downlink Shared Channel (PDSCH). The DMRS and corresponding PDSCH are transmitted using the same precoding matrix. The wireless device does not need to know the precoding matrix to demodulate the transmission. The transmitter may use different precoder matrix for different parts of the transmission bandwidth, resulting in frequency selective precoding. The wireless device may also assume that the same precoding matrix is used across a set of PRBs denoted Precoding Resource Block Group (PRG). Transmission durations from 2 to 14 symbols in a slot may be supported.

The downlink physical-layer processing of transport channels may include transport block cyclic redundancy check (CRC) attachment, code block segmentation and code block CRC attachment, channel coding (LDPC coding), physical-layer hybrid-ARQ processing, rate matching, scrambling, modulation (e.g., QPSK, 16QAM, 64QAM, 256QAM), layer mapping, and mapping to assigned resources and antenna ports. A wireless device may assume that at least one symbol with demodulation reference signal is present on each layer in which PDSCH is transmitted to a wireless device.

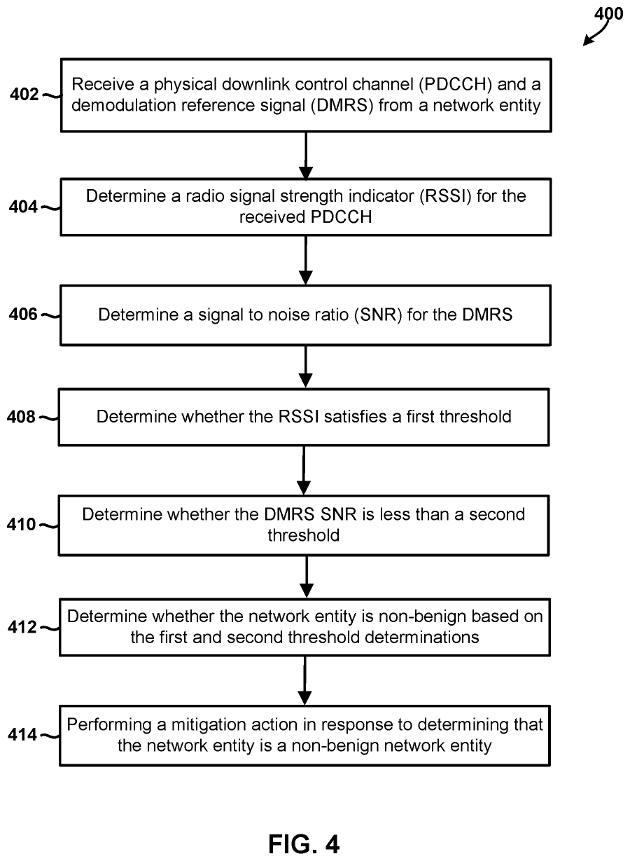

FIGS. 4-8 illustrate methods 400, 500, 600, 700, 800 that may be performed by a processor of wireless device for detecting a jammer that targets physical layer channels in a communication network in accordance with various embodiments.

FIG. 4 illustrates a method 400 that may be performed by a processor of a wireless device for detecting a jammer that targets physical layer channels in a communication network in accordance with various embodiments. With reference to FIGS. 1-4, the method 400 may be implemented by a processor (such as 212, 216, 252 or 260) of a wireless device (such as the wireless devices 120a-120e, 200, 320).

In block 402, a wireless device processor may receive a physical downlink control channel (PDCCH) and a demodulation reference signal (DMRS) from a network entity. In block 404, the wireless device processor may determine a radio signal strength indicator (RSSI) for the received PDCCH. In block 406, the wireless device processor may determine a signal to noise ratio (SNR) for the DMRS.

In block 408, the wireless device processor may determine whether the RSSI satisfies (e.g., meets or exceeds) a first threshold. For example, the wireless device processor may determine whether the RSSI value is greater that a high signal strength threshold.

In block 410, the wireless device processor may determine whether the DMRS SNR is less than a second threshold. For example, wireless device processor may determine whether the DMRS SNR is less than a low SNR threshold.

In block 412, the wireless device processor may determine whether the network entity is non-benign based on the first and second threshold determinations made in blocks 408 and 410.

In block 414, the wireless device processor may perform a mitigation action in response to determining that the network entity is a non-benign network entity. In some embodiments, the processor in the wireless device may update one or more communication parameters to access the communication network using a different frequency, band or system. In some embodiments, the processor in the wireless device may monitor activities of the network entity. In some embodiments, the processor in the wireless device may report the activities of the network entity to a security server of the communication network. In some embodiments, the processor in the wireless device may perform two or more of these mitigation actions.

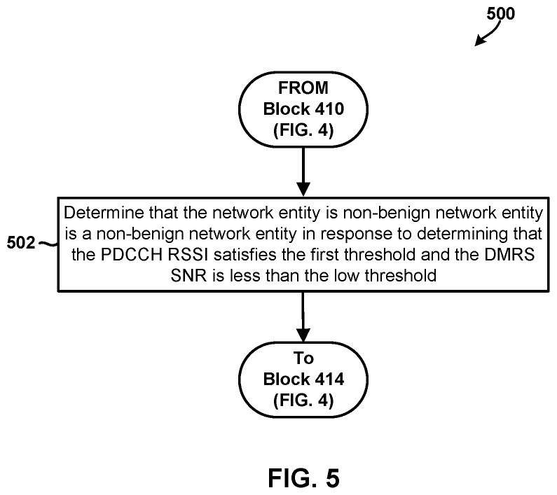

FIG. 5 illustrates a method 500 that may be performed by a processor of a wireless device for detecting a jammer that targets physical layer channels in a communication network in accordance with various embodiments. With reference to FIGS. 1-5, the method 500 may be implemented by a processor (such as 212, 216, 252 or 260) of a wireless device (such as the wireless devices 120a-120e, 200, 320). In the method 500, the wireless device processor may perform operations of blocks 402-410 of the method 400 described with reference to FIG. 4.

In block 502, the wireless device processor may determine that the network entity is non-benign network entity is a non-benign network entity in response to determining that the PDCCH RSSI satisfies the first threshold in block 408 and that the DMRS SNR is less than the low threshold in block 410.

Following the operations of block 502, the processor may perform mitigation actions in the operations of block 414 as described with reference to FIG. 4.

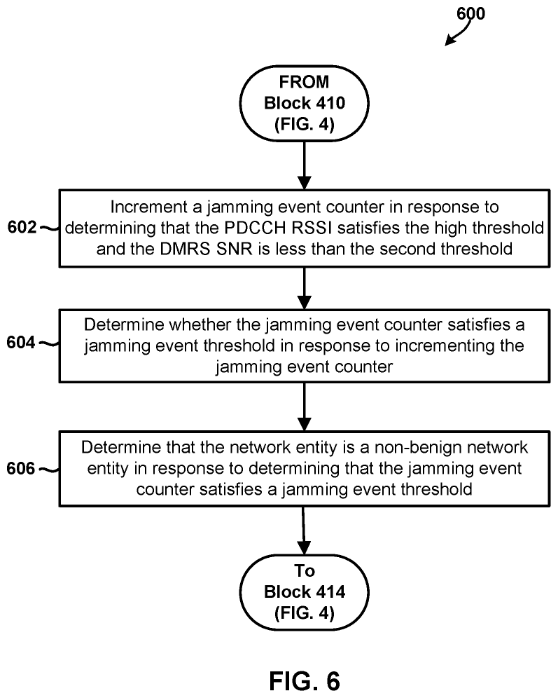

FIG. 6 illustrates a method 600 that may be performed by a processor of a wireless device for detecting a jammer that targets physical layer channels in a communication network in accordance with various embodiments. With reference to FIGS. 1-6, the method 600 may be implemented by a processor (such as 212, 216, 252 or 260) of a wireless device (such as the wireless devices 120a-120e, 200, 320). In the method 500, the wireless device processor may perform operations of blocks 402-410 of the method 400 described with reference to FIG. 4.

In block 602, the wireless device processor may increment a jamming event counter in response to determining that the PDCCH RSSI satisfies the high threshold and that the DMRS SNR is less than the second threshold in block 410.

In block 604, the wireless device processor may determine whether the jamming event counter satisfies (e.g., meets or exceeds) a jamming event threshold in response to incrementing the jamming event counter.

In block 606, the wireless device processor may determine that the network entity is a non-benign network entity in response to determining that the jamming event counter satisfies a jamming event threshold.

Following the operations of block 606, the processor may perform mitigation actions in the operations of block 414 as described with reference to FIG. 4.

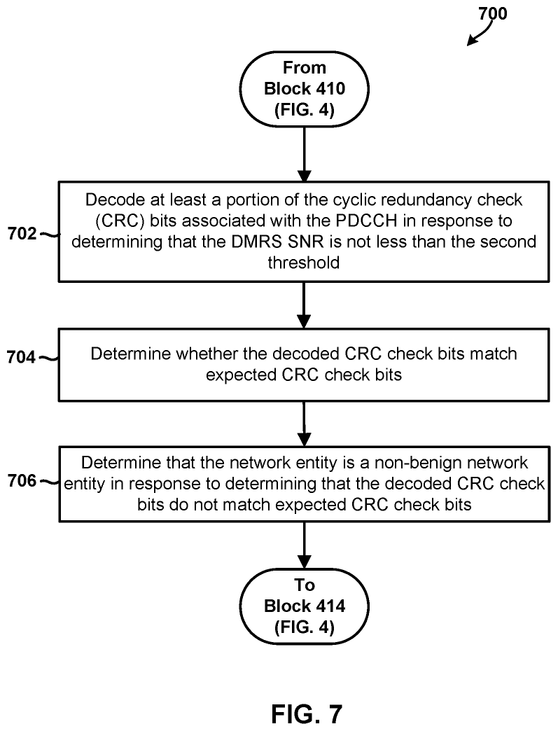

FIG. 7 illustrates a method 700 that may be performed by a processor of a wireless device for detecting a jammer that targets physical layer channels in a communication network in accordance with various embodiments. With reference to FIGS. 1-7, the method 700 may be implemented by a processor (such as 212, 216, 252 or 260) of a wireless device (such as the wireless devices 120a-120e, 200, 320). In the method 700, the wireless device processor may perform operations of blocks 402-410 of the method 400 described with reference to FIG. 4.

In block 702, the wireless device processor may decode at least a portion of the cyclic redundancy check (CRC) bits associated with the PDCCH in response to determining that the DMRS SNR is not less than the second threshold in block 410. Thus, if the SNR of the DMRS is better than the second (e.g., low) threshold, the wireless device processor may decode at least a portion of the CRC.

In block 704, the wireless device processor may determine whether the decoded CRC bits match expected CRC bits.

In block 706, the wireless device processor may determine the network entity is a non-benign network entity in response to determining that the decoded CRC bits do not match expected CRC bits.

Following the operations of block 706, the processor may perform mitigation actions in the operations of block 414 as described with reference to FIG. 4.

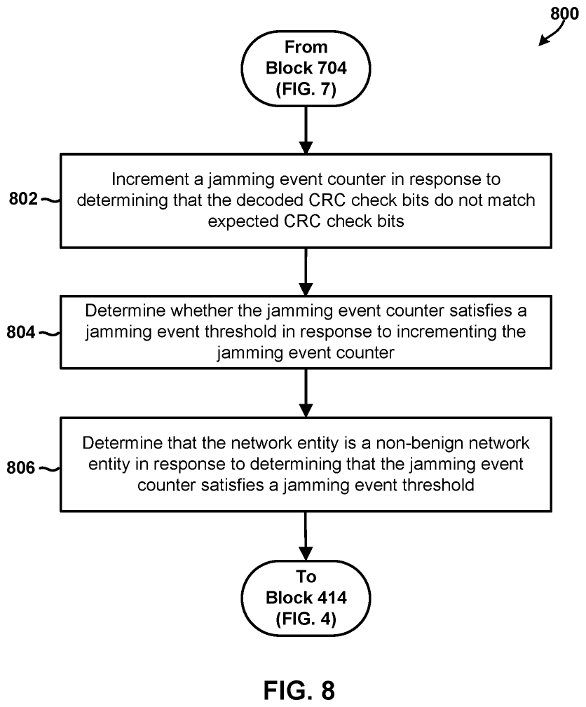

FIG. 8 illustrates a method 800 that may be performed by a processor of a wireless device for detecting a jammer that targets physical layer channels in a communication network in accordance with various embodiments. With reference to FIGS. 1-8, the method 800 may be implemented by a processor (such as 212, 216, 252 or 260) of a wireless device (such as the wireless devices 120a-120e, 200, 320). In the method 800, the wireless device processor may perform operations of blocks 402-410 of the method 400 described with reference to FIG. 4 and blocks 702 and 704 of the method 70 described with reference to FIG. 7.

In block 802, the wireless device processor may increment a jamming event counter in response to determining that the decoded CRC bits do not match expected CRC bits. In block 804, the wireless device processor may determine whether the jamming event counter satisfies (e.g., meets or exceeds) a jamming event threshold in response to incrementing the jamming event counter. In block 806, the wireless device processor may determine that the network entity is a non-benign network entity in response to determining that the jamming event counter satisfies a jamming event threshold.

Following the operations of block 806, the processor may perform mitigation actions in the operations of block 414 as described with reference to FIG. 4.

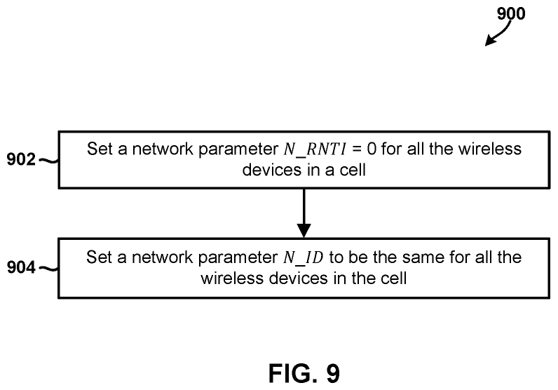

FIG. 9 illustrates a method 900 that may be performed by a processor of a server computing device or network component for detecting a jammer that targets physical layer channels in a communication network in accordance with an embodiment. In blocks 902 and 904, a processor of server computing device or network component may set the non-device specific cyclic redundancy check (CRC) bits associated with a physical downlink control channel (PDCCH) so that the CRC bits are agnostic to (or so the CRC bits are not dependent on) an identity of a target of the PDCCH. In particular, in block 902, the processor may set a network parameter N_RNTI=0 for all the wireless devices in a cell. In block 904, the processor may set a network parameter N_ID to be the same for all the wireless devices in the cell.

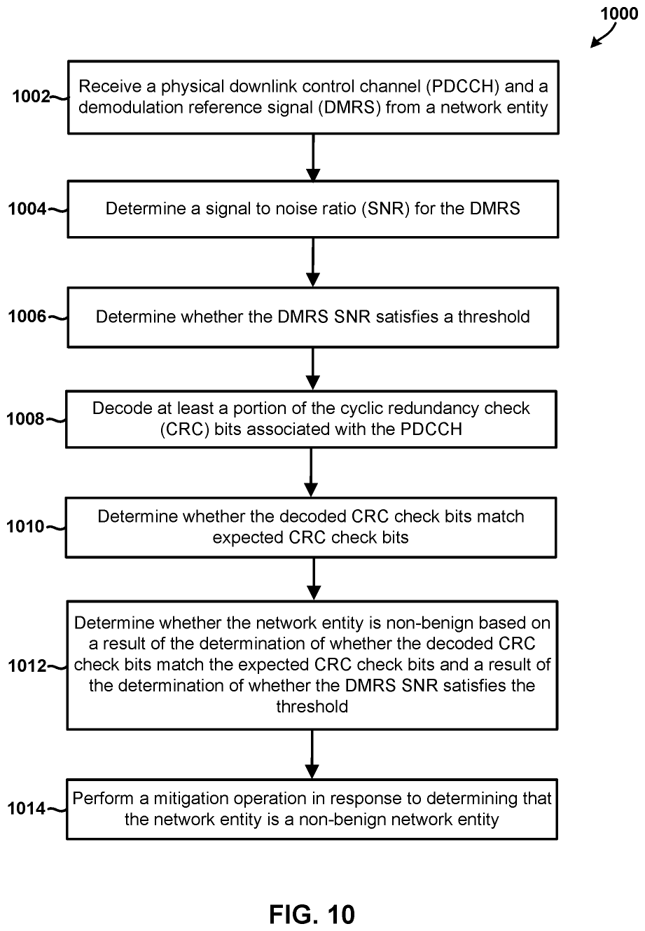

FIG. 10 illustrates a method 1000 that may be performed by a processor of a wireless device for detecting a jammer that targets physical layer channels in a communication network in accordance with an embodiment. With reference to FIGS. 1-8, the method 800 may be implemented by a processor (such as 212, 216, 252 or 260) of a wireless device (such as the wireless devices 120a-120e, 200, 320).

In block 1002, the wireless device processor may receive a physical downlink control channel (PDCCH) and a demodulation reference signal (DMRS) from a network entity. Reception of the PDCCH and DMRS may be performed in accordance with standard wireless protocols. In block 1004, the wireless device processor may determine a signal to noise ratio (SNR) for the DMRS. This determination may be according to standard protocol operations. In block 1006, the wireless device processor may determine whether the DMRS SNR satisfies (e.g., meets or exceeds) a threshold. This may be accomplished by the processor comparing a digital measure of the SNR value to a threshold stored in memory.

In block 1008, the wireless device processor may decode at least a portion of the cyclic redundancy check (CRC) bits associated with the PDCCH. In some embodiments, the wireless device processor may be configured to decode the CRC bits associated with the PDCCH in block 1008 in response to determining that the DMRS SNR satisfies the threshold in block 1006.

In block 1010, the wireless device processor may determine whether the decoded CRC bits match expected CRC bits. In block 1012, the wireless device processor may determine whether the network entity is non-benign based on a result of the determination of whether the decoded CRC bits match the expected CRC bits and a result of the determination of whether the DMRS SNR satisfies the threshold. For example, the wireless device processor may determine that the network entity is non-benign in response to determining that the decoded CRC bits do not match the expected CRC bits and that DMRS SNR does satisfy the threshold.

In block 1014, the wireless device processor may perform a mitigation operation in response to determining that the network entity is a non-benign network entity. Similar to the operations performed in block 414 of the method 400, in some embodiments, the processor in the wireless device may update one or more communication parameters to access the communication network using a different frequency, band or system. In some embodiments, the processor in the wireless device may monitor activities of the network entity. In some embodiments, the processor in the wireless device may report the activities of the network entity to a security server of the communication network. In some embodiments, the processor in the wireless device may perform two or more of these mitigation actions.

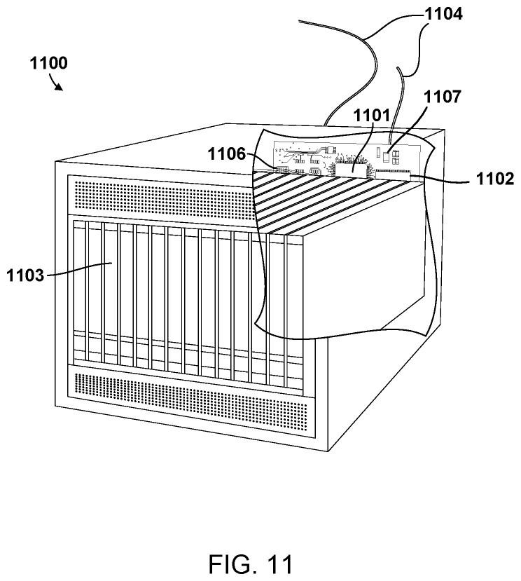

FIG. 11 shows a component block diagram of an example network computing device 1100, such as a base station, suitable for use in various implementations. Such network computing devices may include at least the components illustrated in FIG. 11. With reference to FIG. 1-10, the network computing device 1100 may typically include a processor 1101 coupled to volatile memory 1102 and a large capacity nonvolatile memory, such as a disk drive 1103. The network computing device 1100 also may include a peripheral memory access device such as a floppy disc drive, compact disc (CD) or digital video disc (DVD) drive 1106 coupled to the processor 1101. The network computing device 1100 also may include network access ports 1104 (or interfaces) coupled to the processor 1101 for establishing data connections with a network, such as the Internet or a local area network coupled to other system computers and servers. The network computing device 1100 may include one or more antennas 1107 for sending and receiving electromagnetic radiation that may be connected to a wireless communication link. The network computing device 1100 may include additional access ports, such as USB, Firewire, Thunderbolt, and the like for coupling to peripherals, external memory, or other devices.

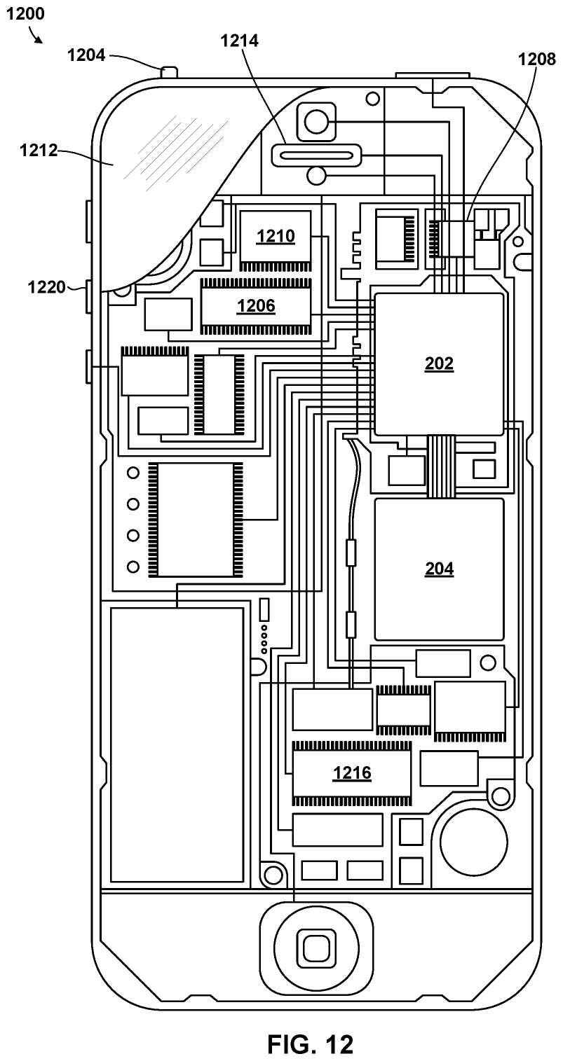

FIG. 12 shows a component block diagram of an example wireless device 1200 suitable for use in various implementations. In various implementations, the wireless device 1200 may be similar to the wireless devices 120a-e, 200, and 320 shown in FIGS. 1A-4. A wireless device 1200 may include a first SOC 202 (such as a SOC-CPU) coupled to a second SOC 204 (such as a 5G capable SOC). The first and second SOCs 202, 204 may be coupled to internal memory 1206, 1216, a display 1212, and to a speaker 1214. Additionally, a wireless device 1200 may include an antenna 1204 for sending and receiving electromagnetic radiation that may be connected to a wireless data link or cellular telephone transceiver 1208 coupled to one or more processors in the first or second SOCs 202, 204. A wireless device 1200 typically also includes menu selection buttons or rocker switches 1220 for receiving user inputs.

A wireless device 1200 also includes a sound encoding/decoding (CODEC) circuit 1210, which digitizes sound received from a microphone into data packets suitable for wireless transmission and decodes received sound data packets to generate analog signals that are provided to the speaker to generate sound. Also, one or more of the processors in the first and second SOCs 202, 204, wireless transceiver 1208 and CODEC 1210 may include a digital signal processor (DSP) circuit (not shown separately).

The processors of a network computing device 1200 and a wireless device 1200 may be any programmable microprocessor, microcomputer or multiple processor chip or chips that can be configured by software instructions (applications) to perform a variety of functions, including the functions of the various implementations described below. In some mobile devices, multiple processors may be provided, such as one processor within an SOC 204 dedicated to wireless communication functions and one processor within an SOC 202 dedicated to running other applications. Typically, software applications may be stored in the memory 1206, 1216 before the applications are accessed and loaded into the processor. The processors may include internal memory sufficient to store the application software instructions.

Various implementations illustrated and described are provided merely as examples to illustrate various features of the claims. However, features shown and described with respect to any given implementation are not necessarily limited to the associated implementation and may be used or combined with other implementations that are shown and described. Further, the claims are not intended to be limited by any one example implementation. For example, one or more of the operations of the methods 400, 500, 600, 700, 800 and 900 may be substituted for or combined with one or more operations of the methods 400, 500, 600, 700, 800 and 900.

The foregoing method descriptions and the process flow diagrams are provided merely as illustrative examples and are not intended to require or imply that the blocks of the various embodiments must be performed in the order presented. As will be appreciated by one of skill in the art the order of blocks in the foregoing embodiments may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm blocks described in connection with the embodiments disclosed herein may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

The functions described for various embodiments may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the claims are not intended to be limited to the embodiments shown herein but are to be accorded the widest scope consistent with the following claims and the principles and novel features disclosed herein.

What is claimed is:

1. A method of detecting a non-benign network entity that targets physical layer channels in a communication network, comprising:
receiving, by a processor in a wireless device, a physical downlink control channel (PDCCH) and a demodulation reference signal (DMRS) from a network entity;
determining, by the processor in the wireless device, a signal to noise ratio (SNR) for the DMRS;
determining, by the processor in the wireless device, whether the DMRS SNR satisfies a threshold;
decoding, by the processor in the wireless device, at least a portion of cyclic redundancy check (CRC) bits associated with the PDCCH;
determining, by the processor in the wireless device, whether the decoded CRC bits match expected CRC bits;
determining, by the processor in the wireless device, whether the network entity is non-benign based on a result of the determination of whether the decoded CRC bits match the expected CRC bits and a result of the determination of whether the DMRS SNR satisfies the threshold; and
performing, by the processor in the wireless device, a mitigation operation in response to determining that the network entity is a non-benign network entity.

2. The method of claim 1, wherein determining whether the network entity is non-benign based on a result of the determination of whether the decoded CRC bits match the expected CRC bits and a result of the determination of whether the DMRS SNR satisfies the threshold comprises determining, by the processor in the wireless device, that the network entity is non-benign in response to determining that:
the decoded CRC bits do not match expected CRC bits; and
the DMRS SNR satisfies the threshold.

3. The method of claim 1, wherein decoding at least a portion of the CRC bits associated with the PDCCH comprises decoding at least a portion of the CRC bits associated with the PDCCH in response to determining that the DMRS SNR satisfies the threshold.

4. The method of claim 1, further comprising:
incrementing, by the processor in the wireless device, a jamming event counter in response to determining that the decoded CRC bits do not match expected CRC bits;
determining, by the processor in the wireless device, whether the jamming event counter satisfies a jamming event threshold in response to incrementing the jamming event counter; and
determining, by the processor in the wireless device, that the network entity is a non-benign network entity in response to determining that the jamming event counter satisfies the jamming event threshold.

5. The method of claim 1, wherein performing the mitigation operation in response to determining that the network entity is a non-benign network entity comprises updating, by the processor in the wireless device, one or more communication parameters to access the communication network using a different frequency, a different band or a different system.

6. The method of claim 1, wherein performing the mitigation operation in response to determining that the network entity is a non-benign network entity comprises monitoring, by the processor in the wireless device, activities of the network entity.

7. The method of claim 1, wherein performing the mitigation operation in response to determining that the network entity is a non-benign network entity comprises reporting activities of the network entity to a security server of the communication network.

8. A wireless device, comprising:
a processor configured with processor-executable instructions to:
receive a physical downlink control channel (PDCCH) and a
demodulation reference signal (DMRS) from a network entity;
determine a signal to noise ratio (SNR) for the DMRS;
determine whether the DMRS SNR satisfies a threshold;
decode at least a portion of cyclic redundancy check (CRC) bits associated with the PDCCH;
determine whether the decoded CRC bits match expected CRC bits;
determine whether the network entity is non-benign based on a result of the determination of whether the decoded CRC bits match the expected CRC bits and a result of the determination of whether the DMRS SNR satisfies the threshold; and
perform a mitigation operation in response to determining that the network entity is a non-benign network entity.

9. The wireless device of claim 8, wherein the processor is further configured to determine whether the network entity is non-benign in response to determining that the decoded CRC bits do not match expected CRC bits and the DMRS SNR satisfies the threshold.

10. The wireless device of claim 8, wherein the processor is further configured to decode at least a portion of the CRC bits associated with the PDCCH in response to determining that the DMRS SNR satisfies the threshold.

11. The wireless device of claim 8, wherein the processor is further configured to:
increment a jamming event counter in response to determining that the decoded CRC bits do not match expected CRC bits;
determine whether the jamming event counter satisfies a jamming event threshold in response to incrementing the jamming event counter; and
determine that the network entity is a non-benign network entity in response to determining that the jamming event counter satisfies the jamming event threshold.

12. The wireless device of claim 8, wherein the processor is further configured to perform the mitigation operation in response to deter mining that the network entity is a non-benign network entity by updating one or more communication parameters to access a communication network using a different frequency, a different band or a different system.

13. The wireless device of claim 8, wherein the processor is further configured to perform the mitigation operation in response to determining that the network entity is a non-benign network entity by monitoring activities of the network entity.

14. The wireless device of claim 8, wherein the processor is further configured to perform the mitigation operation in response to deter mining that the network entity is a non-benign network entity by reporting activities of the network entity to a security server of a communication network.

15. A method of detecting a non-benign network entity that targets physical layer channels in a communication network, comprising:
setting, by a processor in a network component, non-device specific cyclic redundancy check (CRC) bits associated with a physical downlink control channel (PDCCH) so that the CRC bits are agnostic to an identity of a target of the PDCCH.

16. The method of claim 15, wherein setting non-device specific CRC bits associated with the PDCCH so that the CRC bits are agnostic to the identity of the target of the PDCCH comprises setting, by the processor in the network component, a network parameter N_RNTI=0 for devices in a cell.

17. The method of claim 16, wherein setting non-device specific CRC bits associated with the PDCCH so that the CRC bits are agnostic to the identity of the target of the PDCCH further comprises setting, by the processor in the network component, a network parameter N_ID to be the same for devices in the cell.

18. The method of claim 15, further comprising configuring devices in a cell with the same set of control channel element (CCE) aggregation levels to monitor within a control resource set (CORESET).

19. The method of claim 15, further comprising configuring devices in a cell with interleaved for a control resource set (CORESET).

20. The method of claim 15, further comprising configuring devices in a cell with non-interleaved for a control resource set (CORESET).

21. A base station, comprising:
a base station processor configured with processor-executable instructions to:
set non-device specific cyclic redundancy check (CRC) bits associated with a physical downlink control channel (PDCCH) so that CRC bits are agnostic to an identity of a target of the PDCCH.

22. The base station of claim 21, wherein the processor is configured to set the non-device specific CRC bits associated with the PDCCH so that the CRC bits are agnostic to the identity of the target of the PDCCH by setting a network parameter N_RNTI=0 for devices in a cell.

23. The base station of claim 22, wherein the processor is configured to set the non-device specific CRC bits associated with the PDCCH so that the CRC bits are agnostic to the identity of the target of the PDCCH by setting a network parameter N_ID to be the same for devices in the cell.

24. The base station of claim 21, wherein the processor is further configured to configure devices in a cell with the same set of control channel element (CCE) aggregation levels to monitor within a control resource set (CORESET).

25. The base station of claim 21, wherein the processor is further configured to configure devices in a cell with interleaved for a control resource set (CORESET).

26. The base station of claim 21, wherein the processor is further configured to configure devices in a cell with non-interleaved for a control resource set (CORESET).
